(19) United States
(12) Patent Application Publication
(10) Pub. No.: US 2025/0132478 A1
(43) Pub. Date: Apr. 24, 2025

(54) BATTERY CELL

(71) Applicant: SK On Co., Ltd., Seoul (KR)

(72) Inventor: Byeong Hyeon PARK, Daejeon (KR)

(21) Appl. No.: 18/815,851

(22) Filed: Aug. 27, 2024

(30) Foreign Application Priority Data
Oct. 18, 2023 (KR) 10-2023-0139179

(51) Int. Cl. H01M 50/664; H01M 50/103; H01M 50/15

(52) U.S. Cl. CPC H01M 50/664; H01M 50/103; H01M 50/15

(57) ABSTRACT

A battery cell includes a case including an electrode assembly accommodating space in which an electrode assembly and an electrolyte are accommodated, a cap plate covering the electrode assembly accommodating space, an electrolyte injection port formed as a hole penetrating through the cap plate and inclined towards the electrode assembly accommodating space, a terminal portion provided in the cap plate and connected to the electrode assembly, and a temporary sealing member having an outer peripheral surface inclined at an angle corresponding to the electrolyte injection port and inserted into the electrolyte injection port.

### CROSS-REFERENCE TO RELATED APPLICATION(S)

This patent document claims the priority and benefits of Korean Patent Application No. 10-2023-0139179 filed on Oct. 18, 2023, the disclosure of which is incorporated herein by reference in its entirety.

### TECHNICAL FIELD

The disclosure and implementations disclosed in this patent document relate to a battery cell.

### BACKGROUND

Batteries have been widely used in small electronic devices, such as mobile phones and laptops, as well as medium-to-large mechanical devices, such as electric vehicles (EVs) and have the advantage of being rechargeable and reusable.

A battery may be manufactured by accommodating an electrode assembly including a positive electrode plate, a negative electrode plate, and a separator in a case, injecting an electrolyte into the case, and then sealing the case. The case that accommodates the electrode assembly may be of various shapes, such as square, pouch, or cylindrical.

In order to manufacture battery cells that make up batteries, it is necessary to manufacture an electrode assembly by stacking a positive electrode plate, a negative electrode plate, and a separator, accommodating the manufactured electrode assembly in a case, and then injecting an electrolyte.

The process of injecting the electrolyte may be performed multiple times, such as first time and second time. In addition, the battery cell may undergo a modularization process or inspection process even after the electrode assembly and electrolyte are accommodated in the case.

Therefore, the issue of not leaking the electrolyte accommodated in the case of the battery cell, while transferring the battery cell between various processes is very important to improve manufacturing efficiency and productivity of the battery cell.

### SUMMARY

The present disclosure may be implemented in some embodiments to improve efficiency of an operation of injecting an electrolyte into a battery cell.

The present disclosure may also be implemented in some embodiments to improve manufacturing efficiency and productivity of a battery cell.

In addition, the present disclosure may be widely applied in green technology fields, such as solar power generation and wind power generation.

In addition, the present disclosure may be applied to eco-friendly devices, such as eco-friendly electric vehicles and hybrid vehicles to ameliorate climate change by suppressing air pollution and greenhouse gas emissions.

In some embodiments of the present disclosure, a battery cell includes: a case including an electrode assembly accommodating space in which an electrode assembly and an electrolyte are accommodated; a cap plate covering the electrode assembly accommodating space; an electrolyte injection port formed as a hole penetrating through the cap plate and inclined towards the electrode assembly accommodating space; a terminal portion provided in the cap plate and connected to the electrode assembly; and a temporary sealing member having an outer peripheral surface inclined at an angle corresponding to the electrolyte injection port and inserted into the electrolyte injection port.

The electrolyte injection port may be inclined so that a width thereof narrows in a direction of the electrode assembly accommodating space, and the temporary sealing member may include a first inclined region inclined at an angle corresponding to the electrolyte injection port, wherein the first inclined region is inserted into the electrolyte injection port and is in close contact with the cap plate.

The electrolyte injection port may be inclined so that a width in a first end disposed to be closest to the electrode assembly accommodating space is narrowest and a width in a second end disposed to be farthest from the electrode assembly accommodating space is widest.

The electrolyte injection port may have a width linearly decreasing from the second end to the first end.

A width of the temporary sealing member in the first inclined region may have a medium fit tolerance or loose fit tolerance with the electrolyte injection port.

The electrolyte injection port may include a coupling groove dented in a direction of the cap plate, and the temporary sealing member may include a coupling protrusion protruding from the first inclined region and inserted into the coupling groove.

The coupling protrusion may be formed as an outer peripheral surface of the temporary sealing member protrudes, and the coupling protrusion may be present continuously for a certain section in a circumferential direction of the temporary sealing member.

The coupling protrusion may be present in a spiral shape in the first inclined region.

The coupling groove may have a shape corresponding to the coupling protrusion.

The temporary sealing member may include: a shaft portion connected to the first inclined region and present outside the electrolyte injection port; and a handle portion connected to the shaft portion and protruding in an outer surface direction of the shaft portion.

A width of the handle portion may be wider than a maximum width of the electrolyte injection port.

The temporary sealing member may be formed of a material including polyurethane.

### BRIEF DESCRIPTION OF DRAWINGS

Certain aspects, features, and advantages of the present disclosure are illustrated by the following detailed description with reference to the accompanying drawings.

FIG. 1 schematically illustrates a cross-section of a battery cell according to an embodiment of the present disclosure.

FIG. 2 schematically illustrates a portion of a cap plate according to an embodiment of the present disclosure.

FIG. 3 schematically illustrates a cross-section of a battery cell according to another embodiment of the present disclosure.

FIG. 4 schematically illustrates a cross-section of a battery cell according to another embodiment of the present disclosure.

### DETAILED DESCRIPTION

In order to help understanding of the description of the embodiments of the present disclosure, elements denoted with the same reference numerals in the accompanying drawings are the same elements. Some components in the accompanying drawings are exaggerated, omitted, or schematically illustrated, and the size of each component does not completely reflect the actual size.

In addition, in order to clarify the gist of the present disclosure, descriptions of elements and techniques well known in the art may be omitted, and hereinafter, the present disclosure is described in detail with reference to the accompanying drawings.

However, the idea of the present disclosure is not limited to the presented embodiments, and other forms in which specific components are added, changed, or deleted may be proposed by those skilled in the art, but this is also included within the scope of the same idea as the present disclosure.

Hereinafter, the X-axis illustrated in the drawing is a width direction of a case 110 of a battery cell, the Y-axis is a height direction of the case 110 of the battery cell, and the Z-axis is a thickness direction of the case 110 of the battery cell. However, this is an arbitrarily set direction for convenience of description, and the aforementioned directions may be changed.

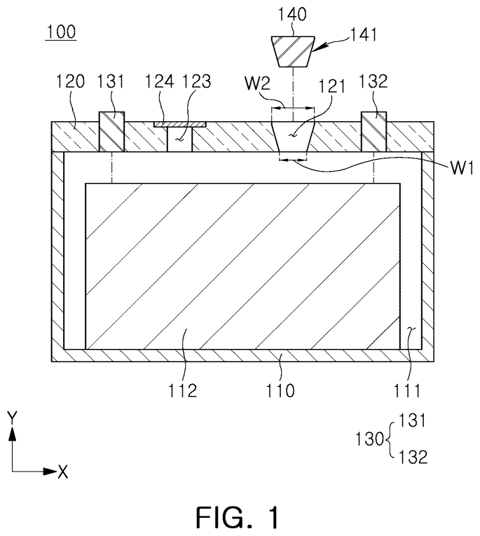

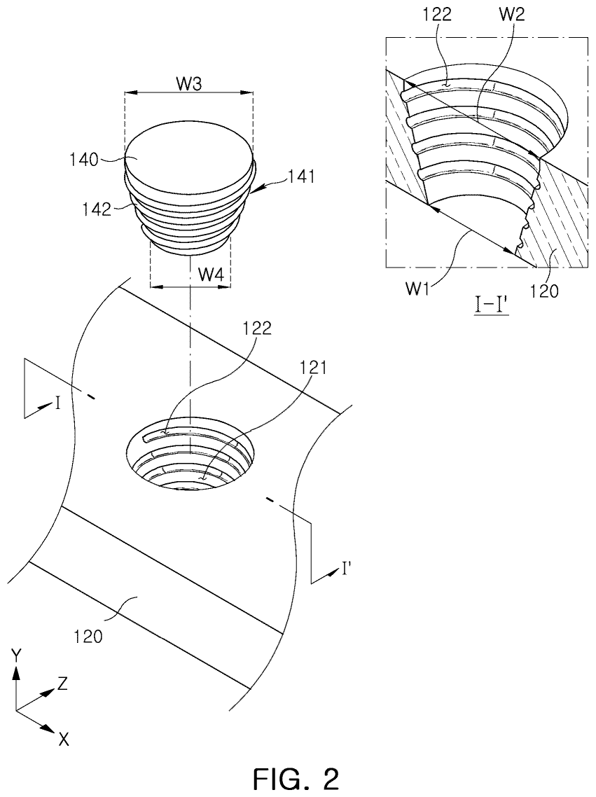

FIG. 1 schematically illustrates a cross-section of a battery cell according to an embodiment of the present disclosure, and FIG. 2 schematically illustrates a portion of a cap plate 120 according to an embodiment of the present disclosure.

As illustrated in FIGS. 1 and 2, the battery cell may include the case 110 including an electrode assembly accommodating space 111 in which an electrode assembly 112 and an electrolyte are accommodated, a cap plate 120 covering the electrode assembly accommodating space 111, an electrolyte injection port 121, which is a hole penetrating through the cap plate 120, inclined in a direction of the electrode assembly space 111, a terminal portion 130 provided in the cap plate 120 and connected to the electrode assembly 112, and a temporary sealing member 140 having an outer peripheral surface provided to be inclined at an angle corresponding to the electrolyte injection port 121 and inserted into the electrolyte injection port 121.

In an embodiment of the present disclosure, the battery cell case 110 may be formed of a rigid material. In an embodiment, the case 110 may have various shapes, such as a rectangular shape, an oval shape including at least one curved portion at a corner, or a circular shape.

The case 110 may have a can shape and may be formed of a metal material including aluminum, an aluminum alloy, stainless steel, etc., but the material is not limited by the present disclosure.

The case 110 may include the electrode assembly accommodating space 111. The case 110 may have an open end in the Y-direction. Accordingly, the electrode assembly accommodating space 111 may have a shape in which one surface parallel to an X-Z plane is open.

The electrode assembly 112 may be accommodated in the electrode assembly accommodating space 111 through the open surface. The electrode assembly 112 may include a positive electrode plate, a negative electrode plate, and a separator interposed between the positive and negative electrode plates.

The cap plate 120 may be coupled to an end in the Y-direction of the case 110 in which the electrode assembly 112 has been completely stored. In an embodiment, the cap plate 120 may be formed of the same material as that of the case 110. In addition, in an embodiment, the cap plate 120 may be welded to the case 110 and may close an open region of the case 110 to seal the case 110.

The cap plate 120 may be provided with the terminal portion 130. The terminal portion 130 may include a first terminal portion 131 electrically connected to the positive electrode plate of the electrode assembly 112 and a second terminal portion 132 electrically connected to the negative electrode plate of the electrode assembly 112. However, this is according to an embodiment, and the positive electrode plate may be connected to the second terminal portion 132, and the negative electrode plate may be connected to the first terminal portion 131. However, the following description will take the case in which the positive electrode plate is connected to the first terminal portion 131 and the negative electrode plate is connected to the second terminal portion 132 as an example.

A positive electrode tab (not illustrated) may be drawn out from the positive electrode plate of the electrode assembly 112, and a negative electrode tab (not illustrated) may be drawn out from the negative electrode plate. The positive electrode tab (not illustrated) and the negative electrode tab (not illustrated) may be drawn out from the electrode assembly 112 in any of the X-, Y-, and Z-directions, and the positive electrode tab (not illustrated) and the negative electrode tab (not illustrated) may be drawn out in the same direction or may be drawn out in different directions.

Meanwhile, the cap plate 120 may include through-holes (not illustrated) into which the first terminal portion 131 and the second terminal portion 132 are respectively inserted. The first terminal portion 131 and the second terminal portion 132 are formed of an electrically conductive material and may be respectively inserted and fixed into the through-holes (not illustrated) of the cap plate 120. The first terminal portion 131 and the second terminal portion 132 may protrude from the cap plate 120 in the +Y-direction by a certain height.

In an embodiment, an insulating member (not illustrated) may be provided between the first terminal portion 131 and the cap plate 120, and an insulating member (not illustrated) may also be provided between the second terminal portion 132 and the cap plate 120. As long as the insulating member has a material and shape that may perform electrical insulation, the material and shape are not limited by the present disclosure.

The positive electrode tab (not illustrated) may be electrically connected to the first terminal 131, and the negative electrode tab may be electrically connected to the second terminal 132. In an embodiment, a current collecting member (not illustrated), etc. may be present inside the case 110 to connect the positive electrode tab (not illustrated) to the first terminal portion 131 and to connect the negative electrode tab (not illustrated) to the second terminal portion 132. At this time, the current collecting member (not illustrated) may be provided to be insulated from an internal surface of the case 110.

In the above, an electrical connection structure of the electrode assembly 112 and the terminal portion has been described, but this is only an example and structures and methods other than those described above may be applied to the structure and method of connecting the electrode assembly 112 to the terminal portion.

A venting hole 123, which is a hole penetrating through the cap plate 120 in the Y-direction, may be provided on one side of the cap plate 120. The venting hole 123 may be connected to the electrode assembly accommodating space 111.

A sealing member 124 may be provided at an end of the venting hole 123 in a +Y-direction (or a positive direction of the Y-axis). The sealing member 124 may close the venting hole 123 and may have a notch (not illustrated).

The sealing member 124 may maintain the venting hole 123 closed under normal conditions. However, if pressure within the electrode assembly accommodating space 111 increases excessively due to venting gas within the electrode assembly accommodating space 111, the sealing member 124 may be damaged by the venting gas, separated from the cap plate 120, or open the venting hole 123.

The cap plate 120 may include the electrolyte injection port 121, which is a hole penetrating through the cap plate 120 in the Y-direction. The electrolyte injection port 121 may be connected to the electrode assembly accommodating space 111 and may have a shape inclined in the Y-direction or in a direction of the electrode assembly accommodating space.

The electrolyte injection port 121 may be inclined so that a width thereof in the X-direction narrows toward the −Y-direction (or a negative direction of the Y-axis). When the electrolyte injection port 121 is inclined in the X-Y cross-section of the cap plate 120, an operation of injecting an electrolyte into the electrode assembly accommodating space 111 in the −Y-direction may be rapidly performed.

In addition, since the electrolyte may be injected into the electrode assembly accommodating space 111 along the inclined surface of the cap plate 120, the electrolyte may be prevented from splashing out of the cap plate 120. Therefore, the precision and accuracy of electrolyte injection work may be improved.

According to the present disclosure, the efficiency of the electrolyte injection process may be improved, and the manufacturing efficiency and productivity of the battery cell may be improved.

A width of the electrolyte injection port 121 in the X-direction may include a first width W1 which is a width in a first end disposed to be closest to the electrode assembly accommodating space 111 and a second width W2, which is a width at a second end farthest from the electrode assembly accommodating space 111.

In the electrolyte injection port 121, the first width W1 is narrowest, the second width W2 is largest, and the value decreases linearly from the second width W2 to the first width W1. When the electrolyte injection port 121 is linearly inclined, the process of machining the electrolyte injection port 121 in the cap plate 120 may be simplified and an unnecessary machining process may be eliminated.

When first electrolyte injection into the electrode assembly accommodating space 111 through the electrolyte injection port 121 is completed, the temporary sealing member 140 may be inserted into the electrolyte injection port 121.

The temporary sealing member 140 may serve to temporarily seal the electrolyte injection port 121 to prevent the electrolyte from leaking out of the case 110 when the battery cell is transferred during a battery cell manufacturing process. The temporary sealing member 140 may temporarily seal the electrolyte injection port 121 and may be removed in a later process. After the temporary sealing member 140 is removed, a second electrolyte injection process of injecting an electrolyte into the electrolyte injection port 121 may be performed.

In an embodiment, the temporary sealing member 140 may include a first inclined region 141 having an external surface inclined at an angle corresponding to the electrolyte injection port 121. The first inclined region 141 has the largest width at the end in the +Y-direction to form the maximum width W3 and has the narrowest width at the end in the −Y-direction to form the minimum width W4. Also, in a section from the maximum width W3 to the minimum width W4, the width may decrease linearly in the −Y-direction.

The first inclined region 141 of the temporary sealing member 140 may be in close contact with the cap plate 120. In an embodiment, the temporary sealing member 140 may be fitted and coupled to the electrolyte injection port 121. In addition, in an embodiment, the temporary sealing member 140 may be provided such that the width of the first inclined region 141 in the X-direction has a medium fit tolerance or a loose fit tolerance with the electrolyte injection port 121. For example, the maximum width W3 of the temporary sealing member 140 may have a medium fit or loose fit tolerance with the second width W2 of the electrolyte injection port 121. In addition, the minimum width W4 of the temporary sealing member 140 may have a medium fit or loose fit tolerance with the first width W1 of the electrolyte injection port 121.

When the temporary sealing member 140 is coupled to the electrolyte injection port 121 using a fitting tolerance, no special adhesive material is required and convenience and efficiency of an operation of inserting the temporary sealing member 140 into the electrolyte injection port 121 and an operation of removing the temporary sealing member 140 from the electrolyte injection port 121 may be improved.

The operation of inserting the temporary sealing member 140 into the electrolyte injection port 121 or the operation of removing the temporary sealing member 140 from electrolyte injection port 121 may be automatically or manually performed.

Meanwhile, in an embodiment of the present disclosure, the temporary sealing member 140 may be formed of a material including polyurethane. Therefore, even if the temporary sealing member 140 comes into contact with the electrolyte, the temporary sealing member 140 may be prevented from being deformed or damaged. In addition, the surface of the cap plate 120 may be prevented from being damaged.

The temporary sealing member 140 formed of a material including polyurethane has flexibility and elasticity, so the temporary sealing member 140 may be more rapidly inserted into the electrolyte injection port 121 and may be more easily in close contact with the cap plate 120 while being inserted in the electrolyte injection port 121.

In addition, the temporary sealing member 140 is easy to maintain due to high impact resistance and wear resistance thereof and has relatively long lifespan during the battery cell manufacturing process due to high waterproofness.

In an embodiment of the present disclosure, the electrolyte injection port 121 may include a coupling groove 122 dented in the direction of the cap plate 120. In addition, a coupling protrusion 142 may be provided in the first inclined region 141 of the temporary sealing member 140. In an embodiment, the temporary sealing member 140 may be formed of an elastic material. By pushing the temporary sealing member 140 into the electrolyte injection port 121, the coupling protrusion 142 may be inserted into the coupling groove 122.

In an embodiment, the coupling protrusion 142 may protrude from the first inclined region 141 toward the cap plate 120 and may exist in a spiral shape surrounding an outer surface (or peripheral surface) of the temporary sealing member 140 in the first inclined region 141.

The coupling protrusion 142 is provided in a shape corresponding to the coupling groove 122 and may be inserted into the coupling groove 122. In an embodiment, the coupling protrusion 142 and the coupling groove 122 may also be provided to have a medium fit or a loose fit tolerance. For example, the coupling groove 122 may be formed by engraving the shape of the coupling protrusion 142 on the cap plate 120. In addition, the coupling protrusion 142 may be provided on the cap plate 120, and the coupling groove 122 may be provided on the temporary sealing member 140.

In an embodiment, the coupling protrusion 142 may be formed integrally with the temporary sealing member 140. The coupling protrusion 142 may be formed so that the outer peripheral surface of the temporary sealing member 140 protrudes toward the cap plate 120.

In addition, in an embodiment, the coupling protrusion 142 may exist continuously in a certain section in the circumferential direction of the temporary sealing member 140. Also, the coupling protrusion 142 may be formed in a spiral shape around the temporary sealing member 140. In addition, the coupling protrusion 142 may exist only in a certain section of the temporary sealing member 140 in the Y-direction. However, this is not limited by the present disclosure and may be appropriately selected and applied depending on the specifications of the battery cell, manufacturing environment, etc.

According to the coupling protrusion 142 and the coupling groove 122, the temporary sealing member 140 may be rotated to be easily coupled to the electrolyte injection port 121. After locating one end of the temporary sealing member 140 in the electrolyte injection port 121, the coupling protrusion 14 may be inserted into the coupling groove 122, and the temporary sealing member 140 may be rotated in a clockwise direction to be inserted into the electrolyte injection port 121.

Conversely, the temporary sealing member 140 may be rotated in a counterclockwise direction to be separated from the electrolyte injection port 121. However, the direction of rotation may change depending on the shape of the coupling protrusion 142 and the coupling groove 122.

Meanwhile, according to another embodiment of the present disclosure, the temporary sealing member 140 may be provided to have a circular or spherical shape. If the temporary sealing member 140 is provided in a circular or spherical shape, the temporary sealing member 140 may be simply rolled toward the electrolyte injection port 121 so that at least a portion of the temporary sealing member 140 may be located inside the electrolyte injection port 121.

In addition, because the electrolyte injection port 121 is inclined, the temporary sealing member 140 may be moved by its own weight in the −Y-direction along the inclined surface of the electrolyte injection port 121. Thereafter, the electrolyte injection port 121 may be sealed with the temporary sealing member 140 by pressing the temporary sealing member 140 as needed. According to the present disclosure, the convenience of the operation of inserting the temporary sealing member 140 into the electrolyte injection port 121 may be improved.

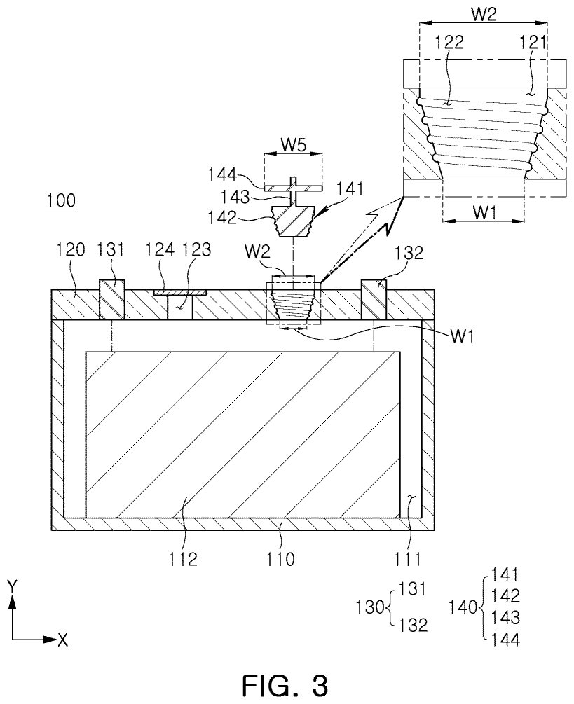

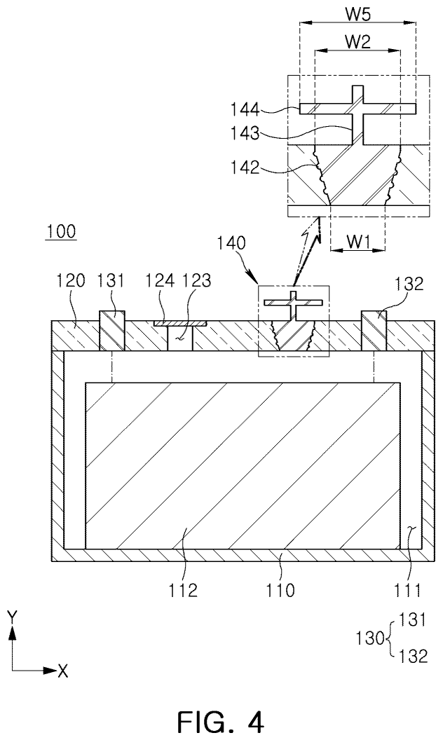

FIGS. 3 and 4 schematically show a cross-section of a battery cell according to another embodiment of the present disclosure.

As illustrated in FIGS. 3 and 4, the temporary sealing member 140 may include a shaft portion 143 connected to the first inclined region 141 in the +Y-direction and having at least a portion exposed to the outside of the electrolyte injection port 121 and a handle portion 144 connected to the shaft portion 143 in the X-direction and protruding in an outer peripheral direction of the shaft portion 143.

The handle portion 144 may extend from the shaft portion 143 in the-X-direction and the +X-direction. A width W5 of the handle portion 144 may have a value larger than the first width W1 and the second width W2.

In an embodiment, the temporary sealing member 140 may include the first inclined region 141, the shaft portion 143, and the handle portion 144 formed as one body. The shaft portion 143 may be formed of the same material as the first inclined region 141.

The handle portion 144 is exposed to the outside of the cap plate 120, so that an operator may grip the handle portion 144 and couple the temporary sealing member 140 to the electrolyte injection port 121 or may easily separate the temporary sealing member 140 from the electrolyte injection port 121.

When coupling or separation of the temporary sealing member 140 is performed automatically, a gripper (not illustrated) coupled to the temporary sealing member 140 may be coupled to the handle portion 144.

Accordingly, the efficiency and speed of inserting the temporary sealing member 140 into the electrolyte injection port 121 and separating the temporary sealing member 140 from the electrolyte injection port 121 may be improved.

Meanwhile, the coupling groove 122 and the coupling protrusion 142 may not only increase the coupling force between the temporary sealing member 140 and the cap plate 120, but may also be easily used when injecting electrolyte into the electrolyte injection port 121.

The coupling groove 122 formed in the electrolyte injection port 121 of the cap plate 120 may be inclined at a certain angle with respect to the X-axis, and in an embodiment, the coupling groove 122 may be inclined in the −Y-direction. In addition, in an embodiment, the coupling groove 122 may be inclined towards the electrode assembly accommodating space 111. According to this, the electrolyte may be injected into the electrolyte injection port 121 along the coupling groove 122. Therefore, the speed at which the electrolyte moves from the electrolyte injection port 121 to the electrode assembly accommodating space 111 may be improved. This may contribute to improving the manufacturing efficiency and productivity of battery cells.

In addition, since the electrolyte, while filling the coupling groove 122, falls into the electrode assembly accommodating space 111 along the coupling groove 122, thereby preventing the or electrolyte from splashing overflowing to the outside of the cap plate 120.

According to the present disclosure, the efficiency of injecting an electrolyte into a battery cell may be improved.

In addition, according to one aspect of the present disclosure, manufacturing efficiency and productivity of battery cells may be improved.

In addition, according to the present disclosure, a battery cell that may be widely applied in green technology fields, such as solar power generation and wind power generation is provided.

In addition, according to the present disclosure, a battery cell that may be applied to eco-friendly devices, such as eco-friendly electric vehicles and hybrid vehicles, to prevent a climate change by suppressing air pollution and greenhouse gas emissions is provided.

Only specific examples of implementations of certain embodiments are described. Variations, improvements and enhancements of the disclosed embodiments and other embodiments may be made based on the disclosure of this patent document.

What is claimed is:

1. A battery cell comprising:
a case including an electrode assembly accommodating space in which an electrode assembly and an electrolyte are accommodated;
a cap plate covering the electrode assembly accommodating space;
an electrolyte injection port formed as a hole penetrating through the cap plate and inclined towards the electrode assembly accommodating space;
a terminal portion provided in the cap plate and connected to the electrode assembly; and
a temporary sealing member having an outer peripheral surface inclined at an angle corresponding to the electrolyte injection port and inserted into the electrolyte injection port.

2. The battery cell of claim 1, wherein
the electrolyte injection port is inclined so that a width thereof narrows in a direction of the electrode assembly accommodating space, and
the temporary sealing member includes a first inclined region inclined at an angle corresponding to the electrolyte injection port, wherein the first inclined region is inserted into the electrolyte injection port and is in close contact with the cap plate.

3. The battery cell of claim 2, wherein the electrolyte injection port is inclined so that a width in a first end disposed to be closest to the electrode assembly accommodating space is narrowest and a width in a second end disposed to be farthest from the electrode assembly accommodating space is widest.

4. The battery cell of claim 3, wherein the electrolyte injection port has a width linearly decreasing from the second end to the first end.

5. The battery cell of claim 4, wherein a width of the temporary sealing member in the first inclined region has a medium fit tolerance or loose fit tolerance with the electrolyte injection port.

6. The battery cell of claim 2, wherein
the electrolyte injection port includes a coupling groove dented in a direction of the cap plate, and
the temporary sealing member includes a coupling protrusion protruding from the first inclined region and inserted into the coupling groove.

7. The battery cell of claim 6, wherein the coupling protrusion is formed as an outer peripheral surface of the temporary sealing member protrudes, and the coupling protrusion is present continuously for a certain section in a circumferential direction of the temporary sealing member.

8. The battery cell of claim 7, wherein the coupling protrusion is present in a spiral shape in the first inclined region.

9. The battery cell of claim 8, wherein the coupling groove has a shape corresponding to the coupling protrusion.

10. The battery cell of claim 2, wherein
the temporary sealing member includes:
a shaft portion connected to the first inclined region and present outside the electrolyte injection port; and
a handle portion connected to the shaft portion and protruding in an outer surface direction of the shaft portion.

11. The battery cell of claim 10, wherein a width of the handle portion is wider than a maximum width of the electrolyte injection port.

12. The battery cell of claim 1, wherein the temporary sealing member is formed of a material including polyurethane.
